(19) United States
(12) Patent Application Publication
(10) Pub. No.: US 2006/0230840 A1
(43) Pub. Date: Oct. 19, 2006

(54) Method and system for modeling valve dynamic behavior using computational fluid dynamics

(75) Inventor: Srikanth Ranganathan, Mason, OH (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC.

(21) Appl. No.: 11/240,476

(22) Filed: Oct. 3, 2005

Related U.S. Application Data
(60) Provisional application No. 60/627,968, filed on Nov. 16, 2004.

(51) Int. Cl. G01F 1/00

(52) U.S. Cl. 73/861

(57) ABSTRACT

A system for modeling fluid flow in a valve (10) includes a section for modeling a main fluid flow domain having an inlet (25), a first outlet (26) and a second outlet using a first grid size, a section for modeling a leakage fluid flow domain (38) having an inlet that includes the main fluid flow domain second outlet and a leakage fluid flow outlet using a second grid size, and a section for iteratively calculating fluid flow in the main fluid flow domain based on leakage flow as determined by the section for modeling leakage fluid flow. Also a method for modeling fluid flow in a valve.

### CROSS REFERENCE TO RELATED APPLICATIONS

The present application claims the benefit of U.S. Provisional Patent Application No. 60/627,968, filed Nov. 16, 2004, the entire contents of which are hereby incorporated by reference.

### STATEMENT OF GOVERNMENT INTEREST

This invention was made with Government support under Contract No. N0019-02-C-3003 awarded by the U.S. Navy. The Government has certain rights in this invention.

### FIELD OF THE INVENTION

The present invention is directed to a method and system for modeling valve behavior, and more specifically, toward a method and system using computational fluid dynamics (CFD) to model dynamic valve behavior.

### BACKGROUND OF THE INVENTION

It is often important to be able to predict how a valve will affect a system in which it is used, for example, what pressure drop will occur across the valve and how much fluid will flow through the valve under various operating conditions. It is often desirable that valves have a high response, in other words, that they are able to adjust rapidly in response to control signals. It is also often desirable that valves exhibit high stability, that is, that the valves reach a desired position without substantially overshooting or fluctuating about the desired position.

Flow through a valve varies with pressure difference across the valve, flow rate, valve stroke, leakage clearance around the valve and temperature. The fact that valve edges are rounded also effects fluid flow. Traditional models of valve operation have been unable to account for such factors as valve leakage and valve edge rounding. Without taking these effects into account, traditional models do not predict valve dynamic behavior accurately. Valves must therefore be manufactured and tested to determine whether they will operate properly under given sets of conditions. This method of producing suitable valves is expensive and time consuming and results in the production of many valves that cannot be used. It is therefore desirable to provide a method and system for modeling valve behavior that takes valve leakage, edge rounding, and other conditions into account and provides more accurate predictions about valve behavior.

### SUMMARY OF THE INVENTION

These problems and others are addressed by the present invention, which comprises, in a first aspect, a method of modeling fluid flow in a valve that involves defining a main fluid flow domain and a leakage fluid flow domain with respect to the valve, modeling the main fluid flow domain using a first grid size without regard to leakage flow, determining a pressure field in the main fluid flow domain, modeling the leakage fluid flow domain using a second grid size smaller than the first grid size, using the main fluid flow domain pressure field to determine a leakage flow and directly calculating a coefficient of discharge for the valve.

Another aspect of the invention comprises a method of modeling fluid flow in a valve that includes steps of a) defining a main fluid flow domain having an inlet and an outlet, b) defining a leakage fluid flow domain having an inlet in communication with the main fluid flow domain and an outlet, c) modeling fluid flow from the main fluid flow domain inlet to the main fluid flow domain outlet assuming no flow to the leakage flow domain, d) determining a pressure in the main fluid flow domain, e) setting a pressure at the leakage fluid flow domain inlet to the pressure and modeling fluid flow from the leakage fluid flow domain inlet to the leakage fluid flow domain outlet, f) determining a leakage fluid flow rate; and g) modeling fluid flow from the main fluid flow domain inlet to the main fluid flow domain outlet assuming leakage flow to the leakage flow domain at the leakage fluid flow rate.

An additional aspect of the invention comprises a system a system for modeling fluid flow in a valve that includes a section for modeling a main fluid flow domain having an inlet, a first outlet and a second outlet using a first grid size, a section for modeling a leakage fluid flow domain having an inlet comprising the main fluid flow domain second outlet and a leakage fluid flow outlet using a second grid size, and a section for iteratively calculating fluid flow in the main fluid flow domain based on leakage flow as determined by the section for modeling leakage fluid flow.

### BRIEF DESCRIPTION OF THE DRAWINGS

The invention will be better understood after a reading of the following detailed description together with the following drawings wherein:

FIG. 1 is a schematic side sectional view of a valve according to an embodiment of the present invention;

FIG. 2 is a schematic side sectional view of an ideal valve positioned within a sleeve with zero clearance;

FIG. 3 is a schematic side sectional view of a valve having rounded edges positioned in a sleeve with a small clearance;

FIG. 4 is a perspective view of the inner surface of the valve sleeve of FIG. 1 having a plurality of circular openings of first and second diameters;

FIG. 5 is a perspective view of an alternate valve sleeve usable with the valve of FIG. 1 that includes several openings having the shape of an exponential window;

FIG. 6 is a graph illustrating the relative apertures available for fluid to flow through the valves of FIG. 2 and FIG. 3 when the valve spool is at a number of different stroke positions;

FIG. 7 illustrates the relative sizes of the circular openings of the valve sleeve of FIG. 4 and illustrates the portions of each opening that will be covered when the spool is at different stroke positions;

FIG. 8a illustrates dynamics equations used for calculating valve behavior under a CFD based approach;

FIG. 8b illustrates dynamics equations used for calculating valve behavior under a traditional approach;

FIG. 8c illustrates a valve model and an equation describing same;

FIG. 9a is a graph comparing a first set of proportionality coefficients obtained using traditional modeling with a set of proportionality constants obtained using the CFD approach;

FIG. 9b is a graph comparing a second set of proportionality coefficients obtained using traditional modeling with a set of proportionality coefficients obtained using the CFD approach;

FIG. 10 is a flow chart outlining the CFD process of the present invention;

FIG. 11a illustrates a relationship between pressure, flow rate and valve stroke predicted by traditional modeling for a given valve;

FIG. 11b illustrates a relationship between pressure, flow rate and valve stroke predicted by CFD based modeling for the valve of FIG. 11a;

FIG. 12a illustrates a relationship between pressure, flow rate and Bernoulli force predicted by traditional modeling for a given valve;

FIG. 12b illustrates a relationship between pressure, flow rate and Bernoulli force predicted by CFD based modeling the valve of FIG. 12a;

FIG. 13a illustrates a relationship between pressure, flow rate and phase margin predicted by traditional modeling for a given valve;

FIG. 13b illustrates a relationship between pressure, flow rate and phase margin predicted by CFD based modeling the valve of FIG. 13a;

FIG. 14a illustrates a relationship between pressure, flow rate and gain margin predicted by traditional modeling for a given valve; and

FIG. 14b illustrates a relationship between pressure, flow rate and gain margin predicted by CFD based modeling the valve of FIG. 14a.

### DETAILED DESCRIPTION

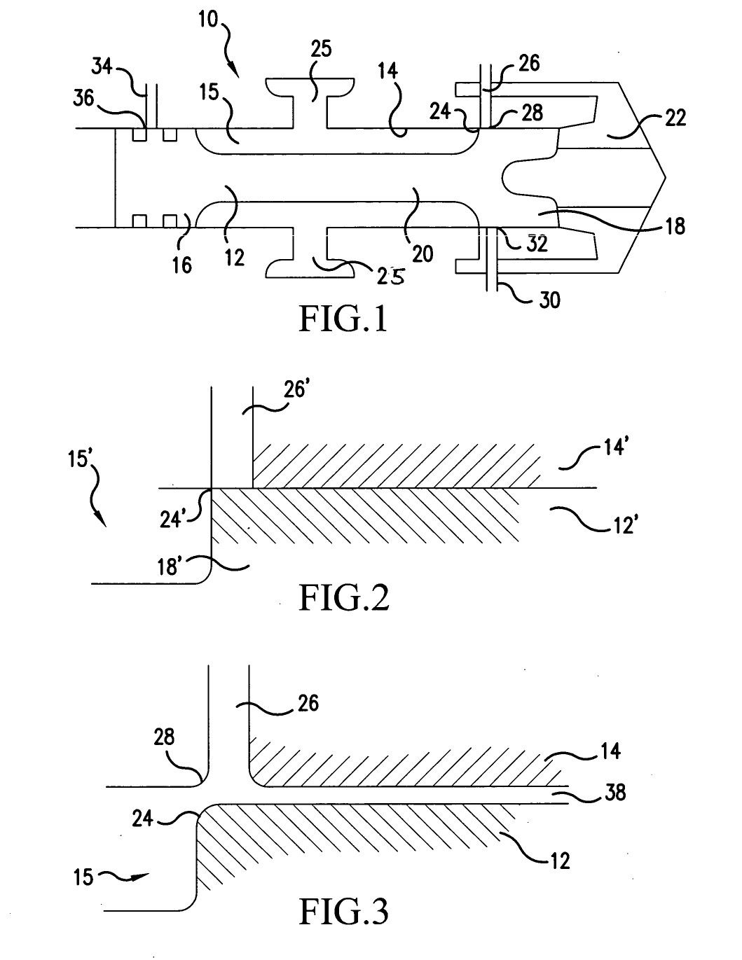

Referring now to the drawings, wherein the showings are for purposes of illustrating preferred embodiments of the invention only, and not for the purpose of limiting same, FIG. 1 illustrates a valve 10 comprising a spool 12 slidingly mounted for reciprocal motion with a sleeve 14 defining an interior space 15. Spool 12 includes a first end 16 and a second end 18 spaced by a central portion 20, the position of spool 12 within sleeve 14 being controlled by an actuator (not shown) and/or by fluid pressure in chamber 22 adjacent second end 18. Second end 18 also includes a corner 24 described hereinafter.

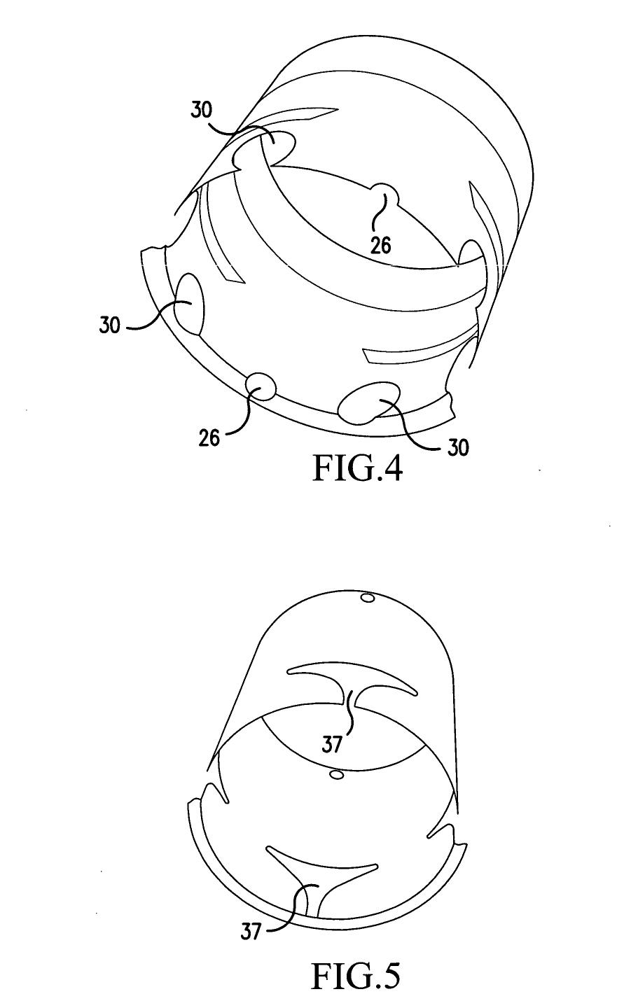

Inlets 25, two of which are shown, provide fuel to valve sleeve 14 between the first and second ends 16, 18 of the spool 12. Fuel flows out of valve 10 through one of several outlets, three of which are illustrated in FIG. 1, namely, a first, small outlet 26, having a radiused end edge 28, a second large outlet 30 having a radiused end edge 32, and a third, damping outlet 34 having a radiused end edge 36. As described below in more detail, the rate of flow depends on the position of spool 12 within sleeve 14. FIG. 4 illustrates one of a variety of possible arrangements of small outlets 26 and large outlets 30 on the inner surface of sleeve 14. FIG. 5 illustrates an alternate arrangement of openings 37 having an exponential window shape which may also be used.

FIG. 2 illustrates second end 18′ of an ideal valve that has a corner 24′ formed as a right angle and a first outlet 26′ that meets sleeve 14′ at a 90 degree angle. There is no clearance between spool 12′ and sleeve 14′ in this ideal valve. Thus, for modeling purposes, there is no flow from space 15′ to outlet 26′ when the spool 12′ is in the zero stroke position illustrated in FIG. 2. There is never a leakage flow because there is no space between spool 12′ and sleeve 14′.

Of course, an actual valve will have a non-zero clearance between its spool and sleeve, and the corner of the valve and the opening of the outlets such as outlet 26′ will not be perfectly square. FIG. 3 illustrates corner 24 as being rounded as well as a rounded end edge on opening 26. A clearance space 38 between spool 12 and sleeve 14 is also illustrated. It should be noted that the relative size of clearance space 38 and the radius of corner 22 and outlets 26 and 30 is exaggerated in these figures for illustration purposes. The actual width of clearance 38 would generally be on the order of 0.0002 inches, while the length of spool 12 would be roughly one inch or so.

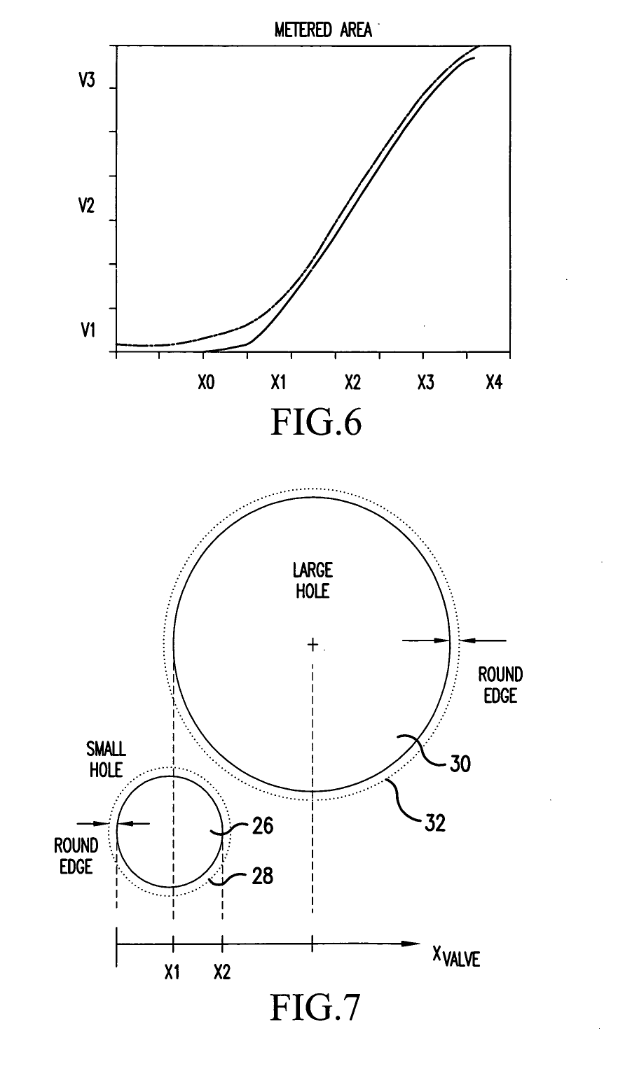

It will therefore be appreciated that, even in the zero stroke position illustrated in FIG. 3, there is a flow path open between interior space 15 and first outlet 26. FIG. 6 graphically illustrates the size of the opening available for fluid flow at different valve strokes where stroke X₀ is the zero stroke position. The size of the available opening between interior space 15 and outlet 26 for the ideal valve of FIG. 2 is 0 at a zero stroke as illustrated by the solid line, while the dashed line illustrates that an opening remains when the stroke is zero at the X₀ position or even negative, that is, when spool 12 is moved further to the left relative to sleeve 14 than the position illustrated in FIG. 3. The difference between the assumed opening size and the actual opening size is small and relatively constant for valve strokes substantially greater than 0; however, the difference does not entirely disappear as valve stroke increases. And, as valve stroke approaches zero, the difference between actual and estimated opening size is significant.

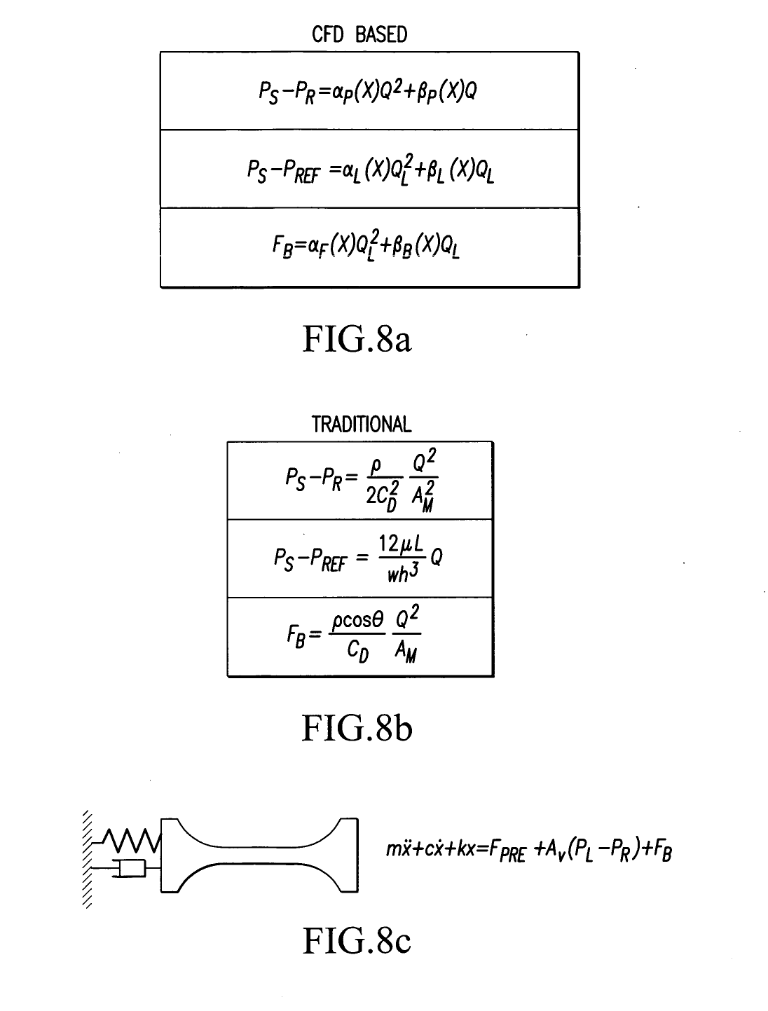

FIG. 8b illustrates the traditional formulas used for estimating valves pressure and forces in connection with a valve disclosed in FIG. 8c. Traditional methods require assumptions for Cd, the coefficient of discharge and theta, the metered jet angle and/or assumptions concerning functional dependencies (pressure drop vs. flow rate). In addition, it has traditionally been assumed that all fluid flow through the valve is turbulent. FIG. 8a illustrates the formulas used in a CFD based valve analysis. In such an analysis, the above assumptions are not required—instead, the system solves for all actual values needed. This systems also allows laminar and turbulent flow to be modeled and avoids the previous requirement that all flow be assumed turbulent. In this manner, a more accurate valve model is produced.

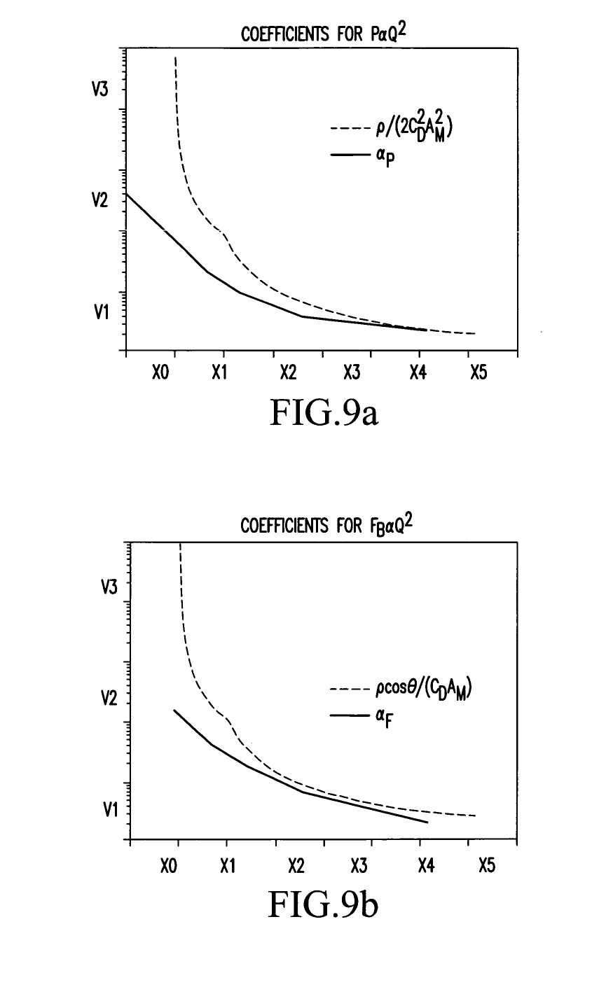

FIGS. 9a and 9b illustrate the differences between the proportionality constants used in a traditional analysis and in a CFD analysis. As will be appreciated from these figures, significant differences are present as stroke decreases to and beyond zero. Indeed, using traditional modeling, the proportionality constant approaches infinity as valve stroke approaches zero; using CFD modeling, non-infinite values are obtained at zero valve stroke and less.

CFD based solutions take the detailed geometry of the valve and sleeve into account. CFD calculations therefore are based on the actual size and configuration of the leakage space on both ends 16, 18 of a spool 12. Even valve eccentricity is accommodated in flow calculations because the shape of the space between the valve and the sleeve is modeled. For this reason, valves that are somewhat cocked or angled within the sleeve can be modeled as well. The data from the CFD based solutions are input into a reformulated dynamic model to predict dynamic behavior. The reformulation incorporates a higher degree of pressure drop-flow rate dependency and more accurate predictions of Bernoulli forces than could previously be obtained.

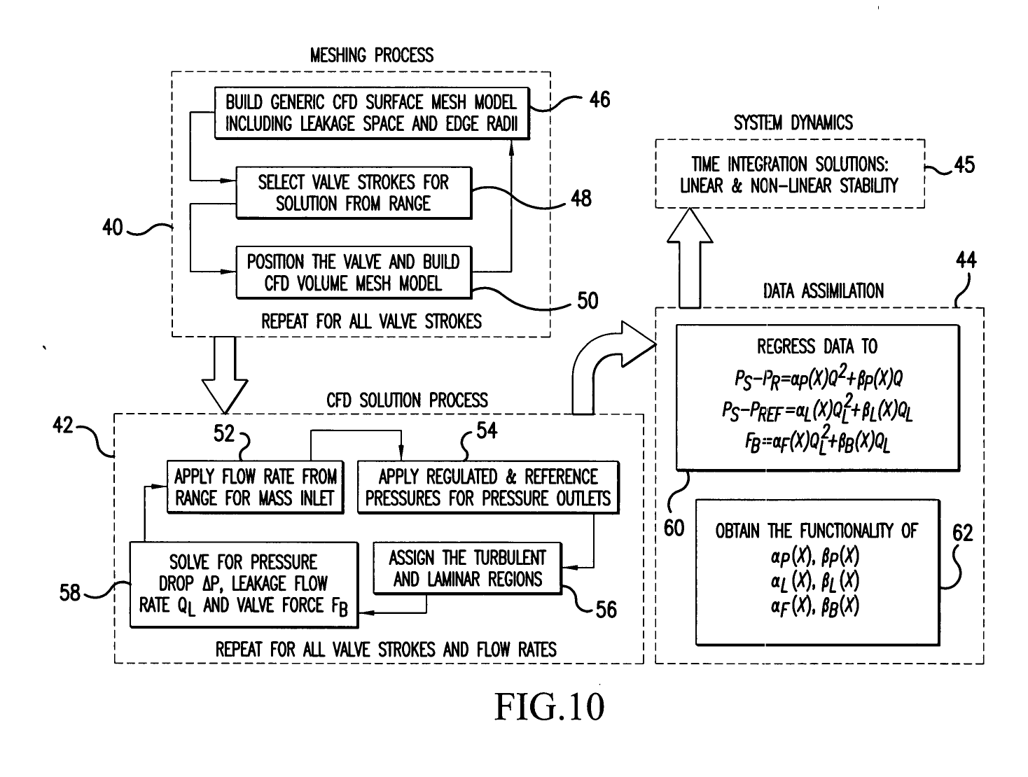

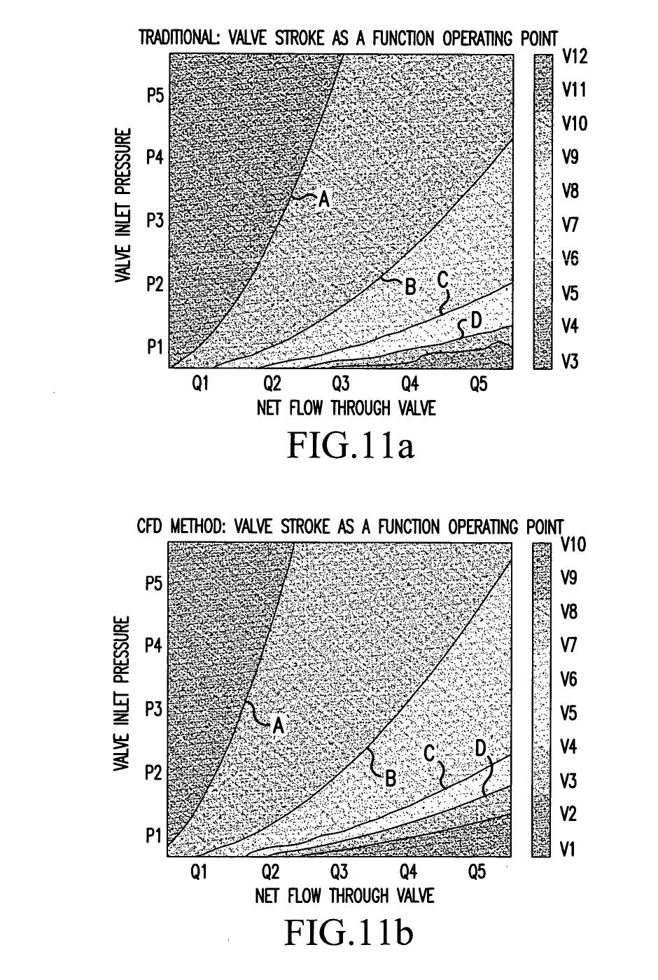

FIG. 10 is a flow chart outlining the CFD method of the present invention. The method is broadly divided into four components, a meshing process step 40, a CFD solution process step 42, a data assimilation step 44 and a system dynamics step 45. In the meshing process 40, a generic CFD surface mesh model is constructed for a valve having a leakage space and rounded edges on internal portions of the valve spool and outlets at a step 46. The meshing process involves defining a main fluid flow domain and a leakage fluid flow domain with respect to the valve and modeling these different domains using different mesh or grid sizes. The main fluid flow domain is modeled using a first grid size without regard to leakage flow and a pressure field in the main fluid flow domain is determined. The leakage fluid flow domain is then modeled using a second mesh or grid size smaller than the first grid size and using the main fluid flow domain pressure field to determine a leakage flow. The main fluid flow domain is then remodeled taking the calculated leakage flow into account. This process can be performed repeatedly until the calculated flow rates converge. A first valve stroke is selected at step 48 from the range of valve strokes to be modeled, and a CFD volume mesh model is constructed for a valve at the given valve stroke at step 50. Steps 48 and 50 are repeated for different valve strokes over a given range.

In the CFD solution process 42, a first flow rate is selected from the range of flow rates to be considered at step 52 and this flow rate is used as input to each of the mesh models constructed at step 50. Regulated and reference pressures are applied to the pressure outlets at step 54 and turbulent and laminar regions are assigned to at step 56. The model is then solved for pressure drop, leakage flow rate and valve force at step 58. When models for all combinations of valve strokes and inlet flow rates have been constructed and solved, the data is regressed at step 60 into the formulas of FIG. 8a, and the functionalities of α_{P}(x), β_{P}(x); α_{L}(x), β_{L}(x); and α_{F}(x), β_{F}(x) are obtained at step 62. From these functionalities, time integration solutions are produced at step 45 to determine linear and non-linear stability.

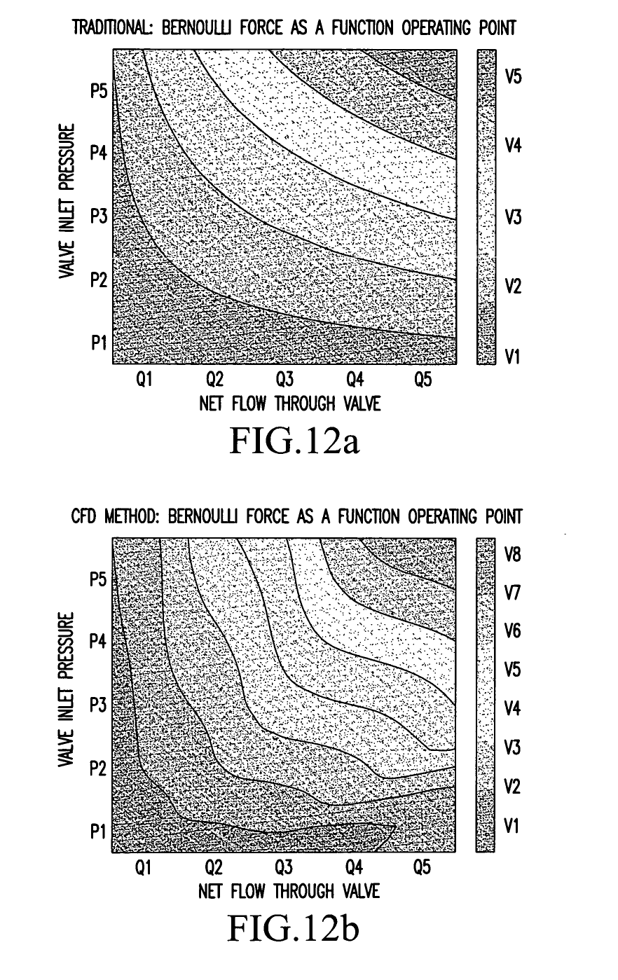

The benefits of using the above process are illustrated in FIGS. 11-14. FIGS. 11a and 11b illustrate the relationships between pressure and flow rate at various valve strokes represented by the lines separating the differently shaded regions. As will be appreciated from these Figures, the CFD process produces significantly different curves than those predicted by traditional analyses. FIGS. 12a and 12b illustrate the different Bernoulli forces predicted by the traditional (FIG. 11a) and CFD based (FIG. 11b) models.

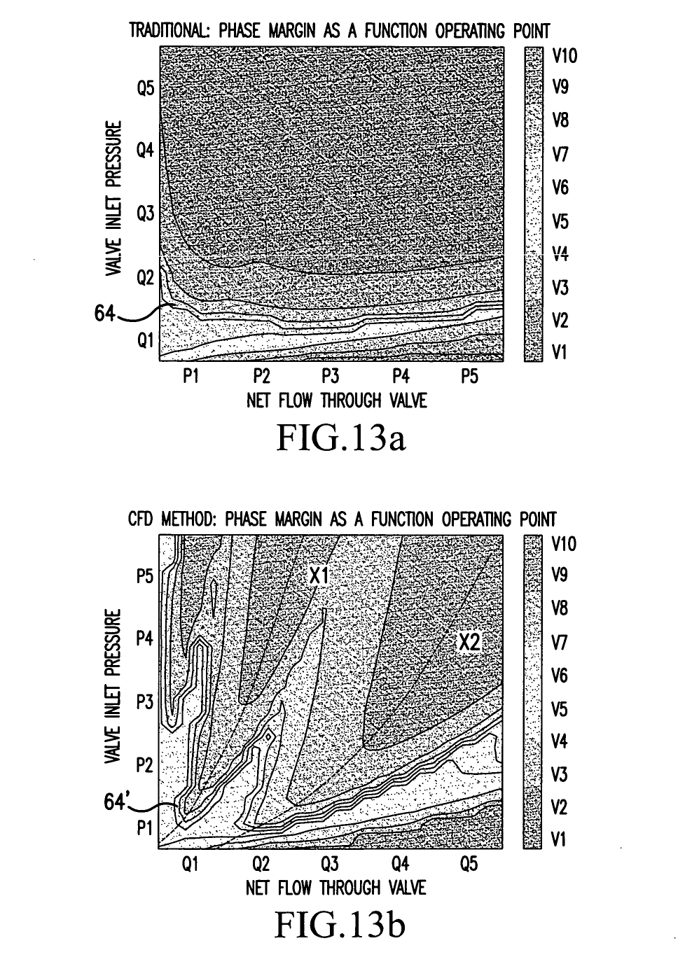

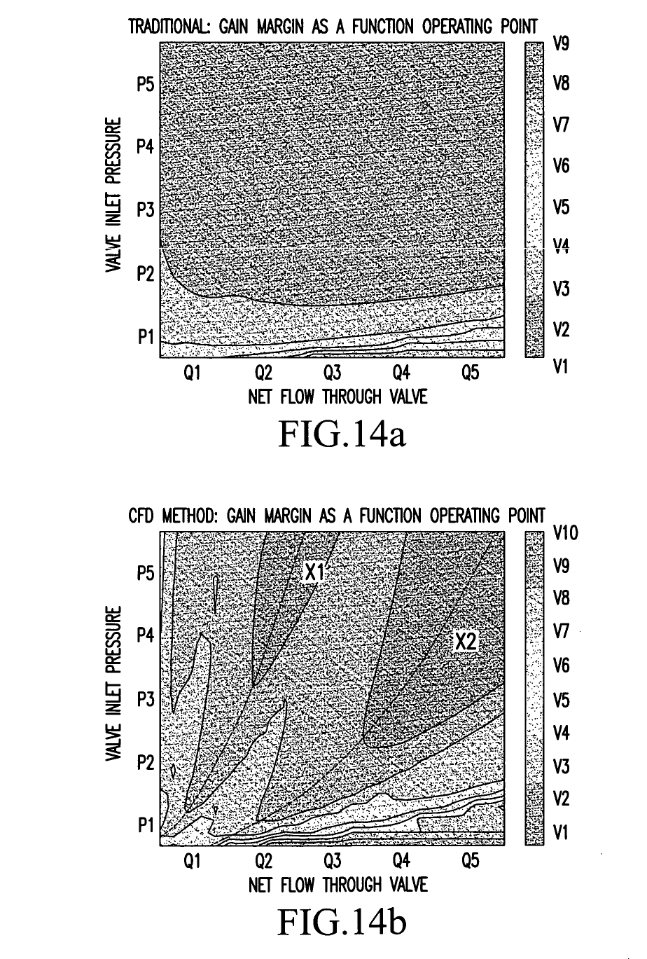

FIG. 13a illustrates predicted phase margins at combinations of pressures and flow rates. Region 64 approximately illustrates the boundary between stable and unstable operation, stable operation occurring only at and below this boundary. Region 64′ as calculated using the CFD approach is of an entirely different shape and illustrates the instabilities that occur at certain valve strokes. With reference to the valve strokes illustrated in FIG. 7 and the graph of FIG. 13b, a first instability can be seen at a valve stroke of X₁ where the small opening is partially uncovered by the moving spool and the large opening begins to open; a second instability can be seen at a valve stroke of X₂ where the small opening is fully open and flow. These regions of instability are not apparent from the traditional model of FIG. 13a. Similar instabilities illustrated by a gain margin model are illustrated in FIGS. 14a and 14b.

The present invention has been described in terms of preferred embodiment. However, additions and modifications will become apparent to those skilled in the relevant arts upon a reading and understanding of the foregoing disclosure. It is intended that all such obvious modifications and additions form a part of the present invention to the extent they fall within the scope of the several claims appended hereto.

What is claimed is:

1. A method of modeling fluid flow in a valve comprising the steps of:
a) defining a main fluid flow domain having an inlet and an outlet;
b) defining a leakage fluid flow domain having an inlet in communication with the main fluid flow domain and an outlet;
c) modeling fluid flow from the main fluid flow domain inlet to the main fluid flow domain outlet assuming no flow to the leakage flow domain;
d) determining a pressure in the main fluid flow domain;
e) setting a pressure at the leakage fluid flow domain inlet to the pressure and modeling fluid flow from the leakage fluid flow domain inlet to the leakage fluid flow domain outlet;
f) determining a leakage fluid flow rate; and
g) modeling fluid flow from the main fluid flow domain inlet to the main fluid flow domain outlet assuming leakage flow to the leakage flow domain at the leakage fluid flow rate.

2. The method of claim 1 including the additional step of:
h) recalculating pressure in the main fluid flow domain given leakage from the main fluid flow domain to the leakage fluid flow domain at the leakage fluid flow rate.

3. The method of claim 2 including the additional step of:
i) recalculating the leakage flow rate at the recalculated pressure.

4. The method of claim 3 including the additional step of: repeating steps h and i.

5. The method of claim 1 wherein said step of defining a main fluid flow domain comprises the step of defining a main fluid flow domain using a first grid size and wherein said step of defining a leakage fluid flow domain comprises the step of defining a leakage fluid flow domain using a second grid size smaller than the first grid size.

6. The method of claim 5 wherein said step of defining a leakage fluid flow domain using a second grid size smaller than the first grid size comprises the step of using a second grid size at least 1000 times smaller than the first grid size.

7. The method of claim 1 including the addition step of directly modeling a coefficient of discharge of the valve or a metered jet angle of the valve.

8. The method of claim 7 including the additional step of modeling both laminar and turbulent regions of fluid flow in the valve.

9. The method of claim 1 including the additional step of modeling both laminar and turbulent regions of fluid flow in the valve.

10. A method of modeling fluid flow in a valve comprising the steps of:
defining a main fluid flow domain and a leakage fluid flow domain with respect to the valve;
modeling the main fluid flow domain using a first grid size without regard to leakage flow;
determining a pressure field in the main fluid flow domain;
modeling the leakage fluid flow domain using a second grid size smaller than the first grid size and using the main fluid flow domain pressure field to determine a leakage flow;
directly calculating a coefficient of discharge for the valve.

11. The method of claim 10 including the additional step of directly calculating a metered jet angle of the valve.

12. The method of claim 10 including the additional step of modeling both laminar and turbulent regions of fluid flow in the valve.

13. A system for modeling fluid flow in a valve comprising:
means for modeling a main fluid flow domain having an inlet, a first outlet, and a second outlet using a first grid size;
means for modeling a leakage fluid flow domain having an inlet comprising the main fluid flow domain second outlet and a leakage fluid flow outlet using a second grid size; and
means for iteratively calculating fluid flow in the main fluid flow domain based on leakage flow as determined by the means for modeling leakage fluid flow.

14. The system of claim 13 including means for iteratively calculating fluid flow in the leakage fluid flow domain based on a pressure in the main fluid flow domain as determined by the means for modeling the main fluid flow domain.

15. The system of claim 13 including means for directly modeling a coefficient of discharge or a metered jet angle of the valve.

16. The system of claim 13 including means for modeling both laminar and turbulent regions of fluid flow in the valve.
